(19) United States
(12) Patent Application Publication
(10) Pub. No.: US 2012/0217888 A1
(43) Pub. Date: Aug. 30, 2012

(54) LED DRIVER CIRCUIT

(75) Inventors: Charles Chang, Hsinchu County (TW); Ronald Chang, Hsinchu County (TW)

(73) Assignee: HANERGY TECHNOLOGIES, INC., Hsinchu County (TW)

(21) Appl. No.: 13/404,405

(22) Filed: Feb. 24, 2012

(30) Foreign Application Priority Data
Feb. 24, 2011 (TW) 100106293

(51) Int. Cl. H05B 37/02

(52) U.S. Cl. 315/200 R

(57) ABSTRACT

The present invention is directed to an LED driver circuit. The LED driver circuit has a control module executing the power factor correction (PFC) by providing a divided voltage being directly proportional to the input voltage to the control module and calculating a feedback signal associated with the input signal.

### CROSS REFERENCE TO RELATED APPLICATION

The application claims the benefit of Taiwan Patent Application No. 100106293, filed on Feb. 24, 2011, in the Taiwan Intellectual Property Office, the disclosures of which are incorporated herein in their entirety by reference.

### FIELD OF INVENTION

The present disclosure relates to a driver circuit. More particularly, the present driver circuit is an LED driver circuit which transfers an AC current into a DC current output for driving the high power LED or the LED arrays via applying the power factor correction (PFC).

### BACKGROUND

The Light-emitting diode (LED) of the drive circuit is always a popular topic of the power electronics. Recently, it becomes more and more important regarding how to produce the design fitting the duration of the product life due to the well-developed processes of the light emitting materials and the strong demand of global market.

The LED has come out for a long period. At first, the LED was used to be a red pilot lamp. Then, the yellow-light, the orange-light, the green-light and the blue-light LEDs were subsequently produced so as to broaden the applying scope of the LED such as using for the traffic light, the lamp, the well lighting (ambient lighting) and the LED-fluorescent lamp, etc. It is simply to drive one or more LEDs when the current is low (about lower than 20 mA). Under such circumstance, applying a linear regulator or a current limiting resistor can achieve the driver circuit when ignoring the loss of power, wherein the current limiting resistor is used to prevent the LED from burning out due to the overload of current. However, the LED driver circuit usually uses the high-effect switching regulator circuit for avoiding the loss of power and/or generating the heat. Moreover, the series connect of LEDs would enlarge the variation range the driving voltage so that the complexity of the driven design is raised.

The LED is a stable light emitter. Via providing the LED with a stable current, it would generate well and precise color and/or brightness of light, lower the raise of temperature caused by the power loss, and comply with any electrical specification, e.g. EN60598, EN61347 or EN60825 or the requirement of green environmental protection, of the environment when used. Please refer to FIG. 1, which is a schematic diagram showing a known Back circuit topology 10 for driving the LED. Back circuit topology 10 has a control module 11 including a reference voltage V2, a current sensing comparator COMP, a RAMP signal, an RS Flip-Flop RS, an oscillator OSC and an LED driving gate, wherein a driving current I1 of the LED is determined by a sensing current I2, and I2 is obtained from the equation I2=V2/R3. One of the driving characters of LED is the dimming capability. The brightness adjustment of LED can be achieved by adjusting the ON/OFF of the current to be higher than 60 Hz. Specifically, the current sensing comparator COMP compares the duty radio of the reference voltage V2 with the RAMP signal added therein a feedback signal so as to generate an output signal. Then, the RS Flip-Flop combines the output signal and a signal from the oscillator to turn on/off the sensing current I2 passing through the LED via the LED driving gate to determine the brightness of the LED.

A Buck topology power supply including the above LED driver circuit as shown in FIG. 1 is able to realize the current drive to the high power LED or the LED arrays. However, if the skilled person in the art applies the LED driver circuit as shown in FIG. 1, the effect of a power factor cannot be raised under the drive by the constant frequency signal. That is, the correction of the power factor is not involved in the design of the LED driver circuit as shown in FIG. 1. Besides, such the Buck topology means that a voltage drop VLED of the LED has to always lower then a DC input current Vin, and therefore a Buck-Boost topology power supply is applied for overcoming the defect of the Buck one. Also, the Buck topology can process the “fixed off time operation” which means that the oscillator would start to count for a fixed period if the output of the current sensing comparator COMP is raised. Moreover, after the modified RAMP signal being added in, a current sensing voltage (i.e. the feedback signal) can decrease the oscillation revealed at the operation under the constant frequency.

For further adjusting the LED load current controlled by the driver circuit, a Floating Ground Buck circuit topology as shown in FIG. 2 is applied. In such the Floating Ground Buck circuit topology, the ground of the driven controller 11 is raised to nearly equipotential to an inductor of the driver circuit, and simultaneously receives the current sensing voltage to control the MOSEFT for more effectively adjusting the driving current I1 flowing to the LED and the driven controller 11 to execute the floating potential operation. However, since some of the components of driven controller 11 cannot stably operate on the ground plane, there are many conflicts between the specifications of these components, which causes a control signal outputting from the LED gate of the driven controller 11 is not advantageous for the purpose of saving energy of the power supply.

FIG. 3 shows another Buck-Boost topology power supply which improves the usage of driving current I1 of the LED and raises the voltage drop VLED of the LED to be higher than DC input current Vin. If the voltage drop VLED is kept near a constant, the driving current I1 of the LED could be obtained from the equation I1(Vin+VLED)/VLED*I2.

Employing experiments and researches full-heartily and persistently, the applicant finally conceived preferable LED driver circuit.

### SUMMARY

The driving method of the present invention provides a simply and effective way to excite the LED and a reference principle for the similar circuit design, which brings great benefit for the popularization of application of the optoelectronics.

The LED is constructed by the P-N junction and generates the light by transferring the current into beams or photons so that the current is in direct proportion to the brightness. The standard wavelength of LED is measured/excited under a specific current, and the wavelength would be changed if the applied current is different from the specific one. Therefore, it is important for effectively controlling the current and simultaneously increasing the speed of the driven.

The present invention is directed to an LED driver circuit having a control module executing the power factor correction (PFC) by providing a divided voltage being directly proportional to the input voltage to the control module and calculating a feedback signal associated with the input signal.

On another aspect, the present invention provides a driver circuit comprising a control module providing a control signal to adjust a load current flowing through a load; and a voltage divider providing a first voltage to the control module and comprising a first resistor and a second resistor connected to the first resistor in series.

On another aspect, the present invention provides a driver circuit comprising a control module providing a control signal to adjust a load current flowing through a load; and a voltage divider providing a first voltage to the control module to improve the power factor.

On another aspect, the present invention provides a driver circuit comprising a control module providing a control signal to adjust a load current flowing through a load; and a voltage divider providing a first voltage to the control module.

On another aspect, the present invention provides a driver circuit having a power factor and comprising a control module; and a voltage divider providing a first voltage to the control module to improve the power factor.

Under the requirements of compact size and high stability of current LED driver circuit, the application of the present LED driver circuit would obviously increase the power factor and comply the requirements of the energy star for LED as better, brighter and more durable.

The skill, improving the difficulty that the driving method of known LED driver circuit is hard to increase under the constant operation frequency, is very important for making the LED qualify various specifications of product, advancing the technical level and even renew the definition of the structure of photoelectric industry. The present LED driver circuit and the method thereof provide a critical solution of the circuit for the applications on driving the relevant photoelectric devise such as the LED-fluorescent lamp or the optical display. Besides, under the requirements of compact size and high stability of current LED driver circuit, the application of the present LED driver circuit would obviously increase the power factor and comply the requirements of the energy star for LED as better, brighter and more durable. Such the advantage is not only being realized on the various kinds of photoelectric product, but also improves the usage of photoelectric elements and the development of photoelectric industry.

In brief, via providing the LED with a stable current, the present invention generates well and precise color and/or brightness of light, lower the raise of temperature caused by the power loss, and comply with any electrical specification, e.g. EN60598, EN61347 or EN60825 or the requirement of green environmental protection, of the environment when used.

### BRIEF DESCRIPTION OF THE DRAWINGS

FIG. 1 shows a known Buck circuit topology.

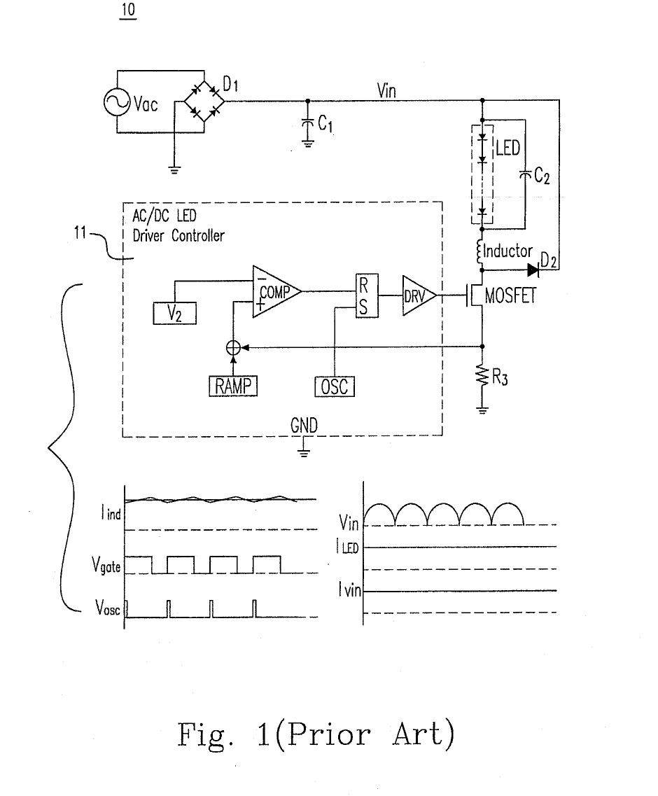

FIG. 2 shows a known Buck-Boost circuit topology.

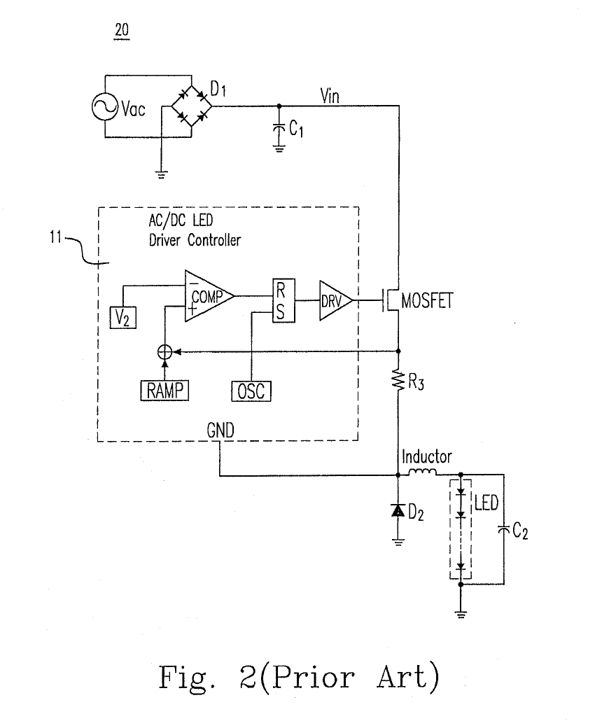

FIG. 3 shows a known Floating Ground Buck circuit topology.

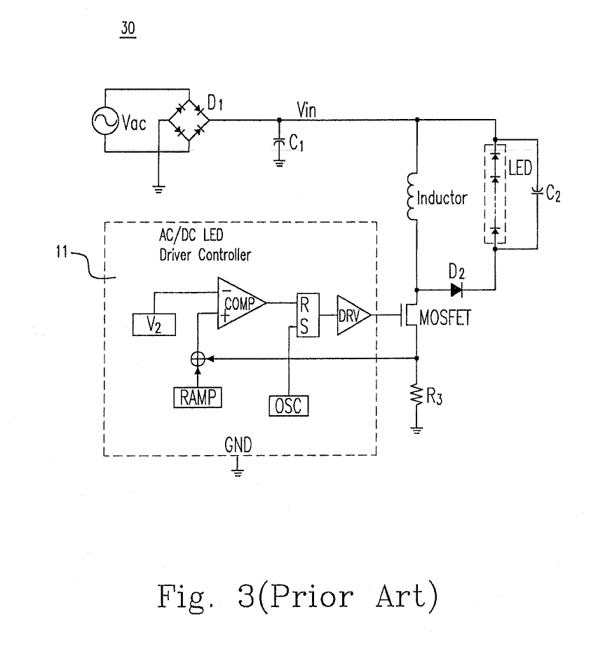

FIG. 4 shows the present driver circuit having PFC function.

### DETAILED DESCRIPTION OF THE PREFERRED EMBODIMENTS

The present invention can be fully understood and accomplish by the skilled person according to the following embodiments. However, the practice of the present method is not limited into following embodiments.

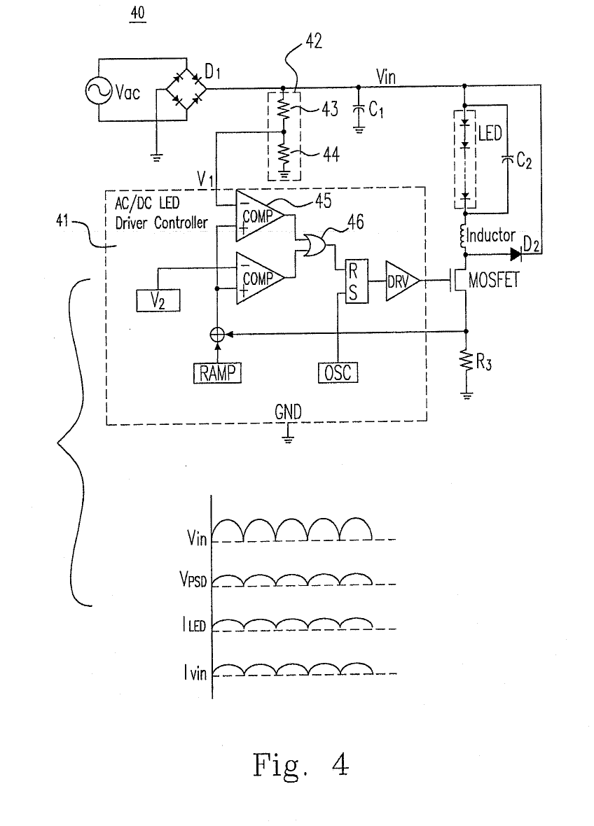

Please refer to FIG. 4 which is the driver circuit of the present invention. The driver circuit 40 comprises a control module providing a control signal to adjust a load current I₁ flowing through a load, and a voltage divider providing a first voltage V₁ to the control module and comprising a first resistor 43 and a second resistor 44 connected to the first resistor 43 in series. The first and the second resistors 43, 44 are coupled to the control module. The driver circuit 40 has a power factor being greater than that of a general LED driver circuit, 0.7. The driver circuit 40 further has a DC input signal with a DC input signal value, wherein the first voltage and the first and the second resistors have a first voltage value and a first and a second resistances respectively, and

$$the first voltage value = the DC input signal value \times \frac{the second resistance value}{the first resistance + the second resistance} .$$

The driver circuit 40 further has an input terminal, an output terminal, a bridge rectifier connected to the input terminal and transferring an AC input voltage signal Vac into a DC input voltage Vin, an inductor providing a stored energy, a MOSFET connected to the output terminal and receiving a signal outputted from the control module, and a third resistor R3 connected to the MOSFET, wherein the third resistor and the MOSFET control the load current jointly. The driver circuit 40 provides a second current I2 and a second voltage having a second voltage value, wherein the third resistor has a third resistance, the second current value I2 is a ratio of the second voltage value V2 to the third resistance, the load current I1 is determined by the second current I2, and the third resistor R3 provides a feedback signal to the control module.

Specifically, in the driver circuit 40, the first voltage value equals to the DC input signal value divided by the sum of the first and the second resistances and then multiplied by the second resistance. When the first voltage V1 is lower then the reference voltage, the sensing current I2 would equal to first voltage value divided by the third resistance, i.e. I2=V2/R3. Accordingly, it is concluded that the driving current I1 of the LED and a DC input current Iin are directly proportional to the DC input voltage Vin, and the phase of the current and the voltage is decreased so as to obtain a higher power factor. Generally, this power factor correction is applicable to a Buck circuit topology 10, a Buck-Boost circuit topology 20, and a Floating Ground Buck circuit topology 30.

In order to make the power factor of LED driver circuit be near to 1 for overcoming the defect of the prior art, the present LED driver circuit 40 is provided and has the power factor being greater than that of a general LED driver circuit, 0.7. The present invention provides enough driving capacity for optical display elements, overcomes the blind spot, e.g. making the designed circuit be suitable for the circuit analysis theory, on the circuit design, and broaden the application scope of the design idea. Also, the present invention hugely improves the technique for increasing the circuit efficiency.

When the power factor correction is applied to drive of LED, the power factor could nearly reach the ideal value, 1, via adjusting the matching of the first and the second resistances 43, 44. The present invention is able to flexibly apply to a variant input voltage including the AC input voltage signal Vac and the DC input voltage Vin for being suitable to various designs of the LED driver controllers and topologies so as to broaden the scope of application. Electronic devices have to comply with the standard of the electromagnetic interference (EMI). A good designing technique for reducing the EMI could decrease the requirements of the wave filter and/or the shield. Accordingly, carefully consideration of the EMI is very important for the cost and the size of the product. Besides, the heat generated from LED driver circuit is quite influence the effect and the power loss of LED. The present invention raises the PFC and the utilization of the electronic power. Moreover, via the feedback signal, the present invention could lower the interference and increase the effect of the circuit so as to decrease the heat and raise the resistance for EMI. By applying the PFC, the AC current is able to transfer into the DC output driving the high power LED or the LED arrays, which generates well and precise color and/or brightness of light via providing the LED with a stable current, and can be applied to LED-fluorescent lamp and photoelectric luminous elements which has to be excited by the drive of circuit. The present invention also raise the operational efficiency of the driver circuit so as to make the product achieve the goal of saving energy of the international regulations. Also, the present invention simplifies the complexity of design of the prior art and raises the driving capacity by applying the PFC.

### Embodiment

Embodiment 1: A driver circuit comprises a control module providing a control signal to adjust a load current flowing through a load, and a voltage divider providing a first voltage to the control module and comprising a first resistor, and a second resistor connected to the first resistor in series.

Embodiment 2 is a driver circuit as described in Embodiment 1, wherein the first and the second resistors are coupled to the control module.

Embodiment 3: A driver circuit as described in Embodiment 1 further has a DC input signal with a DC input signal value, wherein the first voltage and the first and the second resistors have a first voltage value and a first and a second resistances respectively, and

$$the first voltage value = the DC input signal value \times \frac{the second resistance value}{the first resistance + the second resistance} .$$

Embodiment 4: A driver circuit as described in Embodiment 1 further has an input terminal, an output terminal, a bridge rectifier connected to the input terminal and transferring an AC input signal into a DC input voltage, an inductor providing a stored energy, a MOSFET connected to the output terminal and receiving a signal outputted from the control module, and a third resistor connected to the MOSFET, wherein the third resistor and the MOSFET control the load current jointly.

Embodiment 5 is a driver circuit as described in Embodiment 4 which provides a second current and a second voltage having a second voltage value, wherein the third resistor has a third resistance, the second current value is a ratio of the second voltage value to the third resistance, and the load current is determined by the second current.

Embodiment 6 is a driver circuit as described in Embodiment 4, wherein the third resistor provides a feedback signal to the control module.

Embodiment 7: A driver circuit as described in Embodiment 1 further has a power factor being greater than 0.7.

Embodiment 8 is a driver circuit as described in Embodiment 1, wherein the load is an LED.

Embodiment 9 is a driver circuit as described in Embodiment 1 being applied to a Buck circuit topology, a Buck-Boost circuit topology, or a Floating Ground Buck circuit topology.

Embodiment 10: A driver circuit comprises a control module providing a control signal to adjust a load current flowing through a load, and a voltage divider providing a first voltage to the control module.

Embodiment 11: A driver circuit as described in Embodiment 10 further has a power factor, wherein the voltage divider comprises a first resistor and a second resistor, wherein the first and the second resistors are coupled to the control module in series, and the voltage divider provides the first voltage to the control module to improve the power factor.

Embodiment 12: A driver circuit as described in Embodiment 11 further has a DC input signal having a DC input signal value, wherein the first voltage and the first and the second resistors have a first voltage value and a first and a second resistances respectively, and

$$the first voltage value = the DC input signal value \times \frac{the second resistance value}{the first resistance + the second resistance} .$$

Embodiment 13: A driver circuit as described in Embodiment 11 further has a power factor being greater than 0.7.

Embodiment 14 is a driver circuit as described in Embodiment 10, wherein the load is an LED.

Embodiment 15 is a driver circuit as described in Embodiment 1 being applied to a Buck circuit topology, a Buck-Boost circuit topology, or a Floating Ground Buck circuit topology.

Embodiment 16: A driver circuit has a power factor and comprises a control module and a voltage divider providing a first voltage to the control module to improve the power factor.

Embodiment 17 is a driver circuit as described in Embodiment 16, wherein the voltage divider comprises a first resistor and a second resistor, and the first and the second resistors are coupled to the control module in series.

Embodiment 18 is a driver circuit as described in Embodiment 17 further has a DC input signal having a DC input signal value, wherein the first voltage and the first and the second resistors have a first voltage value and a first and a second resistances respectively, and

$$the first voltage value = the DC input signal value \times \frac{the second resistance value}{the first resistance + the second resistance} .$$

Embodiment 19 is a driver circuit as described in Embodiment 16, wherein the power factor being greater than 0.7.

Embodiment 20 is a driver circuit as described in Embodiment 16 being applied to a Buck circuit topology, a Buck-Boost circuit topology, or a Floating Ground Buck circuit topology.

While the disclosure has been described in terms of what is presently considered to be the most practical and preferred embodiments, it is to be understood that the disclosure needs not be limited to the disclose embodiments. Therefore, it is intended to cover various modifications and similar arrangements included within the spirit and scope of the appended claims, which are to be accorded with the broadest interpretation so as to encompass all such modifications and similar structures.

What is claimed is:

1. A driver circuit, comprising:
a control module providing a control signal to adjust a load current flowing through a load; and
a voltage divider providing a first voltage to the control module and comprising:
a first resistor; and
a second resistor connected to the first resistor in series.

2. The driver circuit as claimed in claim 1, wherein the first and the second resistors are coupled to the control module.

3. The driver circuit as claimed in claim 1 further having a DC input signal with a DC input signal value, wherein the first voltage and the first and the second resistors have a first voltage value and a first and a second resistances respectively, and
$$the first voltage value = the DC input signal value \times \frac{the second resistance value}{the first resistance + the second resistance} .$$

4. The driver circuit as claimed in claim 1 further comprising:
an input terminal;
an output terminal;
a bridge rectifier connected to the input terminal and transferring an AC input signal into a DC input voltage;
an inductor providing a stored energy;
a MOSFET connected to the output terminal and receiving a signal outputted from the control module; and
a third resistor connected to the MOSFET, wherein the third resistor and the MOSFET control the load current jointly.

5. The driver circuit as claimed in claim 4 further providing a second current and a second voltage having a second voltage value, wherein the third resistor has a third resistance, the second current value is a ratio of the second voltage value to the third resistance, and the load current is determined by the second current.

6. The driver circuit as claimed in claim 4, wherein the third resistor provides a feedback signal to the control module.

7. The driver circuit as claimed in claim 1 further having a power factor being greater than 0.7.

8. The driver circuit as claimed in claim 1, wherein the load is an LED.

9. The driver circuit as claimed in claim 1 being applied to one selected from a group consisting of a Buck circuit topology, a Buck-Boost circuit topology, and a Floating Ground Buck circuit topology.

10. A driver circuit, comprising:
a control module providing a control signal to adjust a load current flowing through a load; and
a voltage divider providing a first voltage to the control module.

11. The driver circuit as claimed in claim 10 further having a power factor, wherein the voltage divider comprises:
a first resistor; and
a second resistor, wherein the first and the second resistors are coupled to the control module in series, and the voltage divider provides the first voltage to the control module to improve the power factor.

12. The driver circuit as claimed in claim 11 further having a DC input signal having a DC input signal value, wherein the first voltage and the first and the second resistors have a first voltage value and a first and a second resistances respectively, and
$$the first voltage value = the DC input signal value \times \frac{the second resistance value}{the first resistance + the second resistance} .$$

13. The driver circuit as claimed in claim 10 further having a power factor being greater than 0.7.

14. The driver circuit as claimed in claim 10, wherein the load is an LED.

15. The driver circuit as claimed in claim 10 being applied to one selected from a group consisting of a Buck circuit topology, a Buck-Boost circuit topology, and a Floating Ground Buck circuit topology.

16. A driver circuit having a power factor, comprising:
a control module; and
a voltage divider providing a first voltage to the control module to improve the power factor.

17. The driver circuit as claimed in claim 16, wherein the voltage divider comprises:
a first resistor; and
a second resistor, wherein the first and the second resistors are coupled to the control module in series.

18. The driver circuit as claimed in claim 17 further having a DC input signal having a DC input signal value, wherein the first voltage and the first and the second resistors have a first voltage value and a first and a second resistances respectively, and
$$the first voltage value = the DC input signal value \times \frac{the second resistance value}{the first resistance + the second resistance} .$$

19. The driver circuit as claimed in claim 16, wherein the power factor being greater than 0.7.

20. The driver circuit as claimed in claim 16 being applied to one selected from a group consisting of a Buck circuit topology, a Buck-Boost circuit topology, and a Floating Ground Buck circuit topology.
